(19) United States
(12) Patent Application Publication
(10) Pub. No.: US 2023/0068724 A1
(43) Pub. Date: Mar. 2, 2023

(54) Dash-Cam with Thermometer-Based Warning Device

(71) Applicant: Pinchus Biston, Spring Valley, NY (US)

(72) Inventor: Pinchus Biston, Spring Valley, NY (US)

(21) Appl. No.: 17/216,151

(22) Filed: Mar. 29, 2021

(51) Int. Cl. G08B 21/18; G06K 9/00; G08B 7/06; G01K 3/00; G08B 25/10; G01S 19/17; H04W 4/14

(52) U.S. Cl. CPC G08B 21/182; G06K 9/00832; G06K 9/00228; G08B 7/06; G01K 3/005; G08B 25/10; G01S 19/17; H04W 4/14

(57) ABSTRACT

A system and method for providing a temperature-based message warning system for occupants of vehicles is disclosed. The dashcam-message generator includes a dashcam coupled to the dashcam-message generator, a thermometer coupled to the dashcam-message generator, a GPS receiver, a memory having instructions stored thereon; and a processor configured to execute the instructions on the memory. The dashcam-message generator measures an internal temperature of a vehicle using the thermometer, when the internal temperature is greater than a threshold value, the dashcam-message generator obtains images from the dashcam, detects an occupant within the vehicle using the images, generates a warning message regarding the occupant within the vehicle with a temperature above the threshold value, and transmits the warning message to one or more emergency contacts.

### TECHNICAL FIELD

This application relates in general to a system and method for providing a warning system, and more specifically, to a system and method for providing a temperature-based message warning system for occupants of vehicles.

### BACKGROUND

The serious problem exists in which a driver mistakenly leaves a child or pet within a vehicle whether forgotten or intending to return quickly. In too many situations, while the driver is away, the temperature quickly rises to dangerous levels for any occupant in the vehicle. On some occasions, other drivers and individuals passing by the vehicle may realize that the child or pet may be in danger and seek assistance. All too often, the situation is discovered after an occupant has been exposed to these dangerous temperatures for a significant length of time. All the other safety devices require a driver to perform some act every time he/she enters or exits the car that thus requires the driver to remember to activate the system.

Therefore, a need exists for a system and method for providing a temperature-based message warning system for occupants of vehicles according to the present invention. The present invention attempts to address the limitations and deficiencies in prior solutions according to the principles and example embodiments disclosed herein.

### SUMMARY

In accordance with the present invention, the above and other problems are solved by providing a system and method for providing a temperature-based message warning system for occupants of vehicles according to the principles and example embodiments disclosed herein.

In one embodiment, the present invention is a system for providing a temperature-based message warning system for occupants of vehicles according to the present invention. The dashcam-message generator includes a dashcam coupled to the dashcam-message generator, a thermometer coupled to the dashcam-message generator, a GPS receiver, a memory having instructions stored thereon; and a processor configured to execute the instructions on the memory. The dashcam-message generator measures an internal temperature of a vehicle using the thermometer, when the internal temperature is greater than a threshold value, the dashcam-message generator obtains images from the dashcam, detects an occupant within the vehicle using the images, generates a warning message regarding the occupant within the vehicle with a temperature above the threshold value, and transmits the warning message to one or more emergency contacts.

In another aspect of the system and method, the dashcam-message generator further obtains a GPS location of the vehicle, triggers internal warning alarms within the vehicle, retransmits the warning messages after a delay period has passed, and disables the internal warning alarms and reset the dashcam-message generator when the system is reset.

In another aspect of the system and method, the system is reset when an input signal is received from a driver and the vehicle engine is started.

In another aspect of the system and method, the one or more emergency contacts comprises one or more user supplied contacts having a mobile number and an email address.

In another aspect of the system and method, the one or more emergency contacts further comprises a 911 dispatcher, a police department, and rescue services.

In another aspect of the system and method, the warning message is transmitted as an SMS text message.

In another aspect of the system and method, the warning message is transmitted as an email message.

In another aspect of the system and method, the internal warning alarms comprises blowing the vehicle horn and flashing the headlights and turn signals.

In another aspect of the system and method, the occupant is detected within the images using facial recognition.

In another aspect of the system and method, the occupant is detected within the images using motion detection.

In another embodiment, the present invention is a method for providing a temperature-based message warning system for occupants of vehicles according to the present invention. The method measures an internal temperature of a vehicle using the thermometer, when the internal temperature is greater than a threshold value, the dashcam-message generator obtains images from the dashcam, detects an occupant within the vehicle using the images, generates a warning message regarding the occupant within the vehicle with a temperature above the threshold value, and transmits the warning message to one or more emergency contact.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system that provides a temperature-based message warning system for occupants of vehicles according to the present invention.

FIG. 2 illustrates another example embodiment of a system for providing a temperature-based message warning system for occupants of vehicles according to the present invention.

FIG. 3 illustrates a computing system of software components for providing a temperature-based message warning system for occupants of vehicles according to the present invention.

FIG. 4 illustrates a flowchart corresponding to a method performed by software components of a system for providing a temperature-based message warning system for occupants of vehicles according to the present invention.

FIG. 5 illustrates a generalized schematic of a programmable processing system utilized as the various computing components described herein used to implement an embodiment of the present invention.

### DETAILED DESCRIPTION

This application relates in general to a system and method for providing warnings, and more specifically, to a system and method for providing a temperature-based message warning system for occupants of vehicles according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “driver” and “user” refer to an entity, e.g. a human, using the system providing a temperature-based message warning system for occupants of vehicles including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or to wireless connection(s) using any type of frequency/frequencies or radio wave(s). Some examples are included below in this application.

The term “invention” or “present invention” refers to the invention being applied for via the patent application with the title “Dashcam with Thermometer-Based Warning Device.” Invention may be used interchangeably with dashcam.

The terms “communicate” or “communication” refer to any component(s) connecting with any other component(s) in any combination for the purpose of the connected components to communicate and/or transfer data to and from any components and/or control any settings.

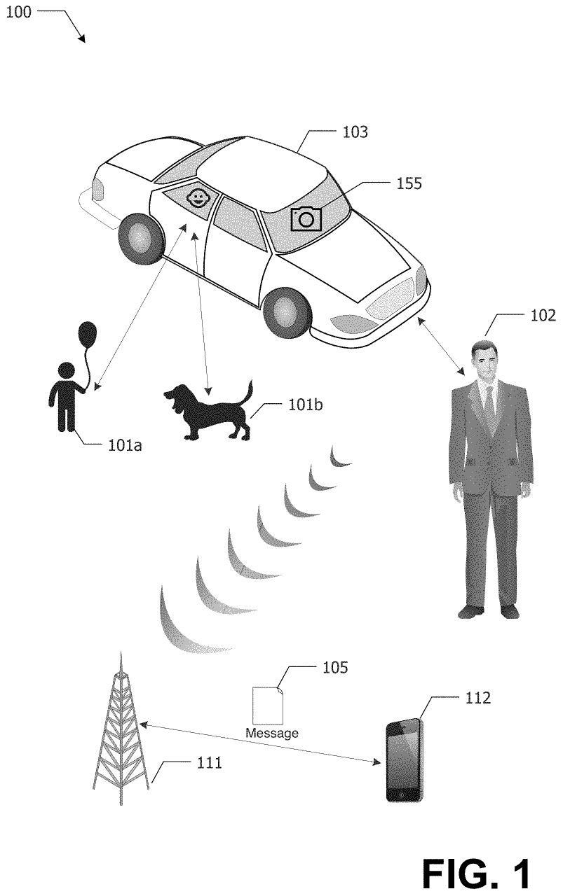

In general, the present disclosure relates to a system and method for providing a warning system. To better understand the present invention, FIG. 1 illustrates an example embodiment of a system that provides a temperature-based message warning system for occupants of vehicles according to the present invention. A driver 102 typically uses a vehicle 103 to transport themselves to various locations. On some occasions, a child 101a or a pet 101b may also accompany the driver 102 on the same trip. For pets 101b and young children 101a, exiting the vehicle 103 requires the driver's 102 assistance. All too often, the driver 102 mistakenly believes that he/she will return quickly or altogether forgets that the other occupant 101a-b is still in the vehicle 103. On sunny days in most climates, the temperature in the vehicle 103 rises quickly and may reach dangerous levels before the driver 102 returns.

A temperature-based message warning system 100 that includes a car dash camera 155 with a temperature sensor may be capable of detecting when someone enters and leaves the vehicle 103, and if the vehicle 103 reaches a dangerous temperature and a detected child or pet remains in the vehicle 103, the temperature-based message warning system 100 may send a warning message 105 to the driver's phone 112. The warning messages 105 may be sent using any available wireless communications network 111 in one of many forms including, but not limited to, emails, voicemails, and SMS text messages. The message may include a date and time of the message, a GPS-based location, a make, model, and description of the vehicle including color, a license plate number, a measured temperature, and one or more emergency contact phone numbers and email addresses.

The available wireless communications network 111 may include 3G, 4G LTE, 5G cellular networks, WiFi networks when present, satellite-based networks, analog and digital radio networks, and any other commercially available wireless communications network supported in the location of the vehicle 103. The temperature-based message warning system 100 may also start beeping or generating other visual and auditory signals to alert nearby individuals of the presence of the dangerous situation. For example, the temperature-based message warning system 100 may be permanently installed into the vehicle 103 such that the system receives electrical power from the electrical system and may operate automatically without any intervention by a user.

In other embodiments, the temperature-based message warning system 100 may also include an emergency button (not shown) that may permit an occupant to trigger the temperature-based message warning system 100 from within the vehicle 103. The temperature-based message warning system 100 may also include an input that permits the driver to enable the system to send the warning messages as disclosed herein upon the detection of an occupant of the vehicle 103 after the vehicle is parked and the engine is turned off regardless of the measured temperature.

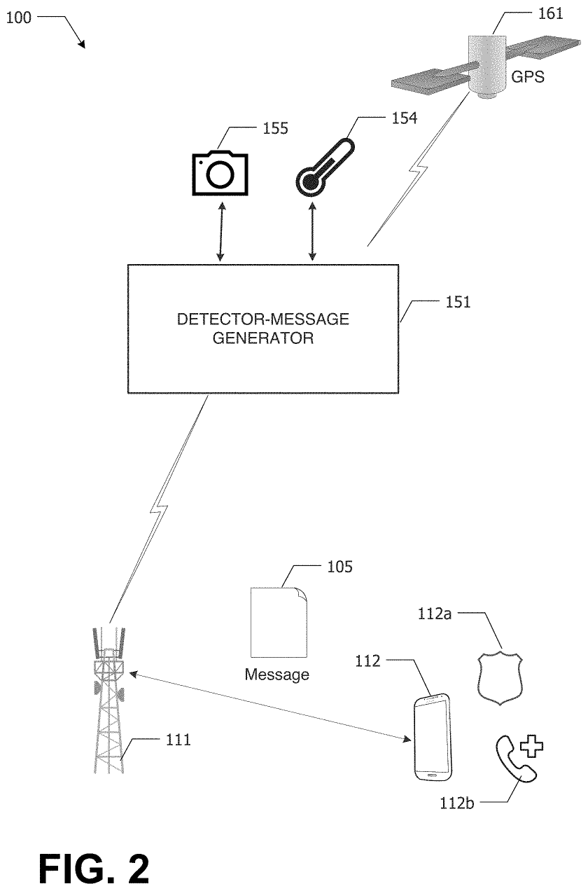

FIG. 2 illustrates another example embodiment of a system for providing a temperature-based message warning system for occupants of vehicles according to the present invention. The detector-message generator 151 is shown coupled to a dashcam 153, a thermometer 155, and a GPS receiver 156 that receives GPS location signals from one or more GPS satellites 161.

The detector-message generator 151 determines when the vehicle 103 has been parked and turned off. The temperature inside the vehicle 103 is obtained by the detector-message generator 151 from thermometer 154. When the internal temperature within the vehicle 103 is greater than a pre-set threshold temperature value, the detector-message generator 151 obtains still images and/or video images from the dashcam 155 and searches these images for an occupant. The detector-message generator 151 may use facial recognition as well as motion detection for detect the occupant including children and pets.

When an occupant is detected, the detector-message generator 151 generates a warning message 105 that is transmitted to one or more emergency contacts 112. These emergency contacts 112 may include the name, mobile number, and email of user specified contacts stored within the detector-message generator 151. The emergency contacts 112 may also include the police department 112a, 911 dispatcher 112b, and any other emergency authorities capable of providing support and rescue services.

Additionally, the emergency contacts may also be location dependent. For example, a user may use properties located in different cities in which the emergency services departments are different. As such, the detector-message generator 151 may attempt to contact one police department when the vehicle 103 is located in the first city and contact a second police department when the vehicle 103 is located in the second city. The GPS location may be used to determine when the vehicle is within a particular city. The user-supplied emergency contacts that identify a nearby family member, co-worker, or neighbor also may be different depending upon location as well.

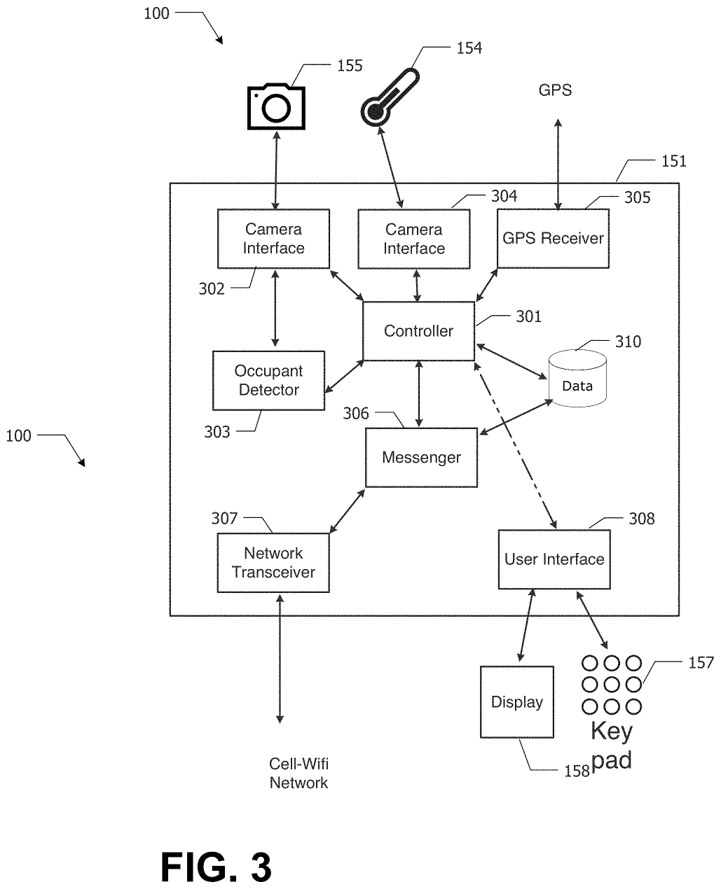

FIG. 3 illustrates a computing system of software components for providing a temperature-based message warning system for occupants of vehicles according to the present invention. The dashcam-message generator 151 is constructed using a set of processing components 301-310 that include a controller 301, a camera interface 302 coupled to the dashcam 155, an occupant detector 303, a thermometer interface 304 coupled to a thermometer 154, a GPS receiver 305, a messenger 306, a network transceiver 307, a user interface coupled to user input 157 and display devices 158, and local data storage 310. These components 309-310 may comprise hardware components, software instructions executed by a programmable device, or a combination of the two. The dashcam 155, thermometer 154, GPS receiver 305, and user input 157 and display devices 158 may be integral to the dashcam-message generator 151 and may also be independent devices electrically coupled to the dashcam-message generator 151.

The controller 301 acts as a central overall controller for the set of processing components 302-310. The controller 301, when activated, commands the dashcam 155 and the thermometer 154 to periodically capture data used to identify when an occupant is present in the vehicle 103 when the temperature is approaching dangerous levels. The controller 301 receives an occupant indication from the occupant detector 303 based upon images provided by the dashcam 155 and temperature readings from the thermometer 154. Using this data, the controller 301 determines when a warning message 105 is to be generated and sent. When a message is being prepared, the controller 301 obtains GPS location data from the GPS receiver 305 that is provided to the messenger 306 along with the date, time, temperature, and an image of the occupant.

User commands from the user interface 308 are received and processed to determine actions to be taken, and then appropriate commands are passed to the other processing components 302-310, as needed, to implement the actions to be taken. The controller 301 may store contact data used as destinations for the warning messages 105 within the local data storage 310 based upon input values received from the input device 157.

The camera interface 302 coupled to the dashcam 155 receives digital images from the dashcam 155 corresponding to an observed occupant, if any, within the vehicle 103. The camera interface 302 processes images and/or video from the dashcam 155 to determine whether someone is still within the vehicle 103. The camera interface 302 provides the images to the occupant detector 303. The camera interface 302 also may receive audio data from the dashcam 155 along with video data that may be used to identify an occupant within the vehicle 103.

In one possible embodiment, the camera interface 302 may receive images from the dashcam 155 and recognize faces of occupants as they enter the vehicle 103. These images may be retained and used by the occupant detector 303 to identify non-moving occupants by matching an occupant's face from these retained images in images obtained inside the vehicle 103 once the temperature reaches dangerous levels.

The occupant detector 303 receives the image data from the camera interface 302 to detect the presence of an occupant within the vehicle 103. The occupant detector 303 may receive still images and/or video with audio data to identify a child or pet for example. The occupant detector 303 may utilize motion detection of objects within images to identify possible moving objects and then may use facial recognition and related item identification to be found within the received images. The occupant detector 303 may also utilize just the facial recognition processing to identify an occupant whether or not the occupant is moving. The occupant detector 303 may use a combination of such processing to determine when an occupant is within the vehicle 103. Upon determining the presence of an occupant, the occupant detector 303 transmits data and images to the controller 301 for use in determining whether a warning message 105 is needed.

The thermometer interface 304 coupled to a thermometer 154 receives electrical signals from a thermometer 154 corresponding to an observed temperature within the vehicle 103. The thermometer interface 304 samples and processes the electrical signals to determine a temperature value that may be sent to the controller 301. The thermometer interface 304 may be configured to provide the temperature using both Fahrenheit and Celsius temperature scales as desired.

The GPS receiver 305 generates current GPS data location data for the dashcam-message generator 151 using signals received from GPS satellites. The GPS receiver 305 generates the location coordinates when commanded by the controller 301. The GPS controller 305 may also maintain a current location value to provide a last known location in place of a current location value when the GPS receiver 305 is unable to receive a live signal from a GPS satellite which may occur when the dashcam-message generator 151 and the vehicle 103 are within parking structures and buildings.

The messenger 306 generates the warning messages 105 upon command from the controller. The messenger 306 receives current data including GPS location data, the date, time, temperature, and an image of the occupant from the controller 301. The messenger 306 retrieves emergency contact information stored within the local data storage 310 used as destination addresses for the warning messages 105. Using this data, the messenger 306 generates the warning message 105 and transmits a copy of the message to each of the parties identified within the emergency contact information.

The emergency contact information may include home, work, and mobile telephone numbers for the driver, the vehicle owner, and other responsible parties entered by a user. The emergency contact information also may include police, 911 dispatchers, and hospitals as appropriate. The emergency contact information may specify a region in which the contact information is to be used. For example, the dashcam-message generator 151 may be configured to recognize that the GPS location obtained from the GPS receiver is either near a driver's work, home, or vacation property. Each of these locations may utilize different police and emergency services organizations and a user may specify different emergency contacts for each of these locations. The messenger 306 may use the GPS location data and these values associated with the emergency contacts to send the warning messages 105 to the relevant parties. The messenger 306 may also send a first warning message to one set of contacts, such as only the driver, and a second warning message to other contacts when the driver does not respond within a specified time period and the temperature remains at dangerous levels.

The network transceiver 307 permits the dashcam-message generator 151 to communicate with emergency authorities' computing devices 112a-b and mobile devices 112. The network transceiver 307 performs all of the data formatting, computer-to-computer communications, encryption processing, and all similar operations needed by the dashcam-message generator 151 to communicate with over available communications networks including Wifi and cellular networks. The dashcam-message generator 151 may include a network transceiver 307 that may communicate using one or more networks that use any available network detected at the location of the vehicle 103.

The user interface coupled to user input 157 and display devices 158 provides a mechanism for a user and driver 102 to enter data and commands into the dashcam-message generator 151 for use in generating and sending warning messages 105. For example, a driver 102 may enter the various phone numbers and email addresses to be used when a warning message 105 is to be sent. This data may be entered using a keypad 157 that is electrically coupled to the dashcam-message generator 151. This data also may be received from a mobile application running on a mobile device such a smartphone or tablet that is communicatively coupled to the dashcam-message generator 151. In some embodiments, the mobile devices may be communicating with the dashcam-message generator 151 using a wireless data connection such as a Bluetooth™ communications link established between the devices. The dashcam-message generator 151 utilizes the display devices 158 to provide data to the users as needed. This display data also may be communicated wirelessly to a mobile application.

The local data storage 310 is semi-permanent data storage, such as a solid state memory device 310, that may be used to store data for use by the processing components 310-309 as needed. The local data storage 310 supports both storing data within the memory device as well as reading data from the memory device as needed. Existing data also may be deleted from the local data storage 310 based upon commands from the user interface 308 and the controller 301.

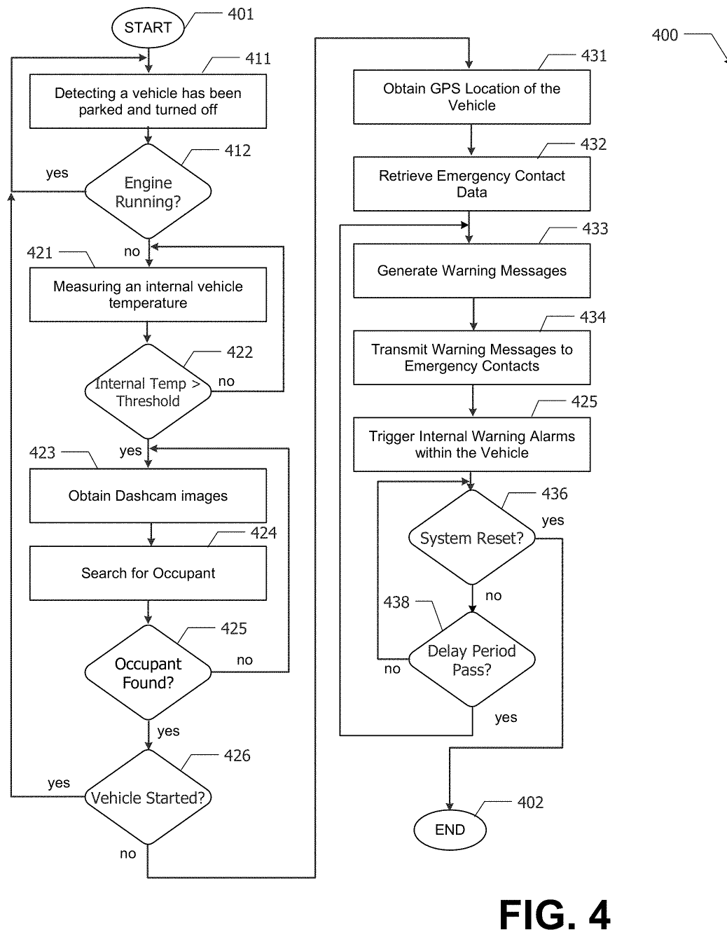

FIG. 4 illustrates a flowchart corresponding to a method performed by software components of a system for providing a temperature-based message warning system for occupants of vehicles according to the present invention. The process 400 begins 401 with the detector-message generator 151 detecting the vehicle 103 has been parked in step 411. In test step 412, detector-message generator 151 determines whether the engine has been turned off, and if not, the process 400 returns to step 411.

When the engine has been turned off, the detector-message generator 151 receives an internal temperature of the vehicle 103 in step 421. In test step 422, detector-message generator 151 determines whether the internal temperature of the vehicle 103 is above a pre-set threshold value, and if not, the process 400 returns to step 421. When the internal temperature is above the pre-set threshold value, the process 400 obtains one or more dashcam images in step 423 and searches for an occupant in the vehicle 103 in step 424. The dashcam images may be a set of video image frames and/or a still image.

The detector-message generator 151, in test step 425, determines whether an occupant has been detected, and if not, the process 400 returns to step 423; otherwise the detector-message generator 151 determines in test step 426 whether the vehicle engine has been started, and if it has, the process 400 returns to 411. When the detector-message generator 151 has determined in test step 426 that vehicle has not been started, the process 400 proceeds to prepare and send a warning message.

In step 431, the detector-message generator 151 obtains a GPS location of the vehicle 103, retrieves one or more emergency contacts in step 432, and generate a warning message 105 using the date and time, temperature, GPS location, and emergency contacts in step 433. The detector-message generator 151 transmits the warning message 105 to the emergency contacts in step 434 and triggers the activation of internal alarms of the vehicle 103 in step 435. The detector-message generator 151, in test step 436 determines whether the detector-message generator 151 has been reset, and if so, the process 400 ends 402.

When the detector-message generator 151 determines in test step 436 that the detector-message generator 151 has not been reset, test step 437 determines if the time since a prior warning message 105 was sent is greater than a preset time delay, and if not the process 400 returns to test step 435. When test step 436 determines that the time since the prior warning message is greater than the pre-set time delay, the process 400 returns 433 to generate and transmit another warning message to the emergency contacts. This process 400 continues until the detector-message generator 151 has been reset manually or by restarting the vehicle engine.

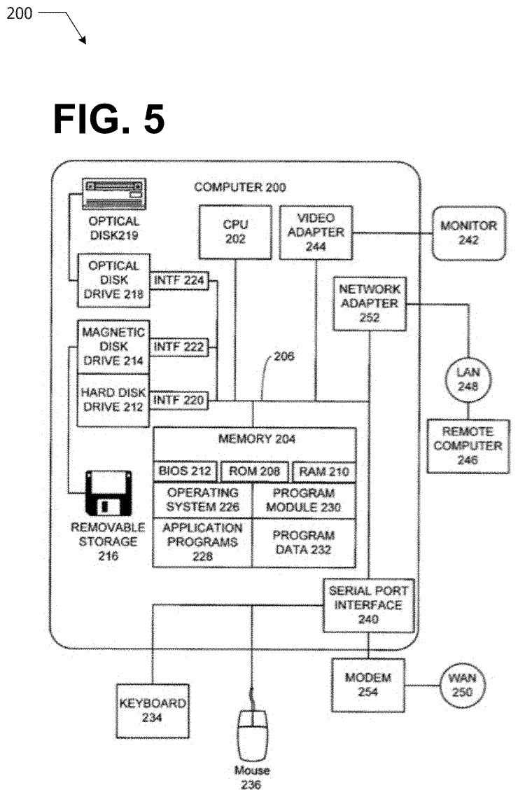

FIG. 5 illustrates a generalized schematic of a programmable processing system utilized as the various computing components described herein used to implement an embodiment of the present invention. The detector-message generator 151 may be implemented as a digital processing system 200 that contains software in the form of executable instructions stored within memory of the system controller 112. When the CPU 202 executes these instructions in memory, the system controller 112 performs the functions of the system 100 as described herein.

The CPU 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of this computer system 200. Rather the computer system 200 is provided as an example of one type of computing device that may be adapted to perform the functions of a temperature-based warning message system, including servers, personal computers, and mobile devices as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

1. A system for providing a temperature-based message warning system for occupants of vehicles by a dashcam-message generator, the system communicatively connected to a plurality of client devices over the Internet, the dashcam-message generator comprising:
a dashcam coupled to the dashcam-message generator;
a thermometer coupled to the dashcam-message generator;
a GPS receiver;
a memory having instructions stored thereon; and
a processor configured to execute the instructions on the memory to cause the dashcam-message generator to:
a thermometer coupled to the dashcam-message generator;
a GPS receiver;
a memory having instructions stored thereon; and
a processor configured to execute the instructions on the memory to cause the dashcam-message generator to:
measure an internal temperature of a vehicle using the thermometer;
when the internal temperature is greater than a threshold value, perform the following steps:
obtain images from the dashcam;
detect an occupant within the vehicle using the images;
generate a warning message regarding the occupant within the vehicle with a temperature above the threshold value; and
transmit the warning message to one or more emergency contacts.

2. The system according to claim 1, wherein the processor further configured to execute the instructions to cause the dashcam-message generator to:
obtain a GPS location of the vehicle;
trigger internal warning alarms within the vehicle;
retransmit the warning messages after a delay period has passed; and
disable the internal warning alarms and reset the dashcam-message generator when the system is reset.

3. The system according to claim 2, wherein the system is reset when an input signal is received from a driver; and
the vehicle engine is started.

4. The system according to claim 1, wherein the one or more emergency contacts comprises one or more user supplied contacts having a mobile number and an email address.

5. The system according to claim 4, wherein the one or more emergency contacts further comprises a 911 dispatcher, a police department, and rescue services.

6. The system according to claim 5, wherein the warning message is transmitted as an SMS text message.

7. The system according to claim 5, wherein the warning message is transmitted as an email message.

8. The system according to claim 5, wherein the internal warning alarms comprises blowing the vehicle horn and flashing the headlights and turn signals.

9. The system according to claim 1, wherein the occupant is detected within the images using facial recognition.

10. The system according to claim 1, wherein the occupant is detected within the images using motion detection.

11. A method for providing a temperature-based message warning system for occupants of vehicles, the method comprising:
measuring an internal temperature of a vehicle using the thermometer;
when the internal temperature is greater than a threshold value, performing the following steps:
obtaining images from a dashcam;
detecting an occupant within the vehicle using the images;
generating a warning message regarding the occupant within the vehicle with a temperature above the threshold value; and
transmitting the warning message to one or more emergency contacts.

12. The method according to claim 11, wherein the further comprising:
obtaining a GPS location of the vehicle;
triggering internal warning alarms within the vehicle;
retransmitting the warning messages after a delay period has passed; and
disabling the internal warning alarms and reset the dashcam-message generator when the system is reset.

13. The method according to claim 12, wherein the system is reset when an input signal is received from a driver; and
the vehicle engine is started.

14. The method according to claim 11, wherein the one or more emergency contacts comprises one or more user supplied contacts having a mobile number and an email address.

15. The method according to claim 14, wherein the one or more emergency contacts further comprises a 911 dispatcher, a police department, and rescue services.

16. The method according to claim 15, wherein the warning message is transmitted as an SMS text message.

17. The method according to claim 15, wherein the warning message is transmitted as an email message.

18. The method according to claim 15, wherein the internal warning alarms comprises blowing the vehicle horn and flashing the headlights and turn signals.

19. The method according to claim 11, wherein the occupant is detected within the images using facial recognition.

20. The method according to claim 11, wherein the occupant is detected within the images using motion detection.
